(19) United States
(12) Patent Application Publication
(10) Pub. No.: US 2011/0210855 A1
(43) Pub. Date: Sep. 1, 2011

(54) TEMPERATURE SENSITIVE ALARM CIRCUIT

(75) Inventor: YONG-ZHAO HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/763,122

(22) Filed: Apr. 19, 2010

(30) Foreign Application Priority Data
Feb. 26, 2010 (CN) 201010114891.5

(51) Int. Cl. G08B 17/06

(52) U.S. Cl. 340/595

(57) ABSTRACT

A temperature controlling alarm circuit includes a power source including a high level terminal and a low level terminal, the low level terminal being grounded; a thermal diode including an anode and a cathode, the anode connected to the high level terminal; a resistor connected to the thermal diode in series; another resistor parallelly connected in parallel to the thermal diode and the said resistor which connected in series; a pnp-type transistor including a base, an emitter and a collector, the base and the emitter being respectively connected to two terminals of the another resistor; and an alarm connected between the collector of the PNP-type transistor and the low level terminal of the power source.

### BACKGROUND

1. Technical Field

This present disclosure relates to alarm circuits, and particularly, to a temperature sensitive alarm circuit.

2. Description of Related Art

There are situations such as in the operation of a greenhouse or cooling room that ambient temperature to be controlled precisely. Known temperature sensitive alarm circuits that are currently commercially available are relatively complex and costly. Thus, in some applications where precise control is not necessary, the known temperature alarm circuit is too expensive for the purpose.

Therefore, it is desirable to provide an alarm circuit for temperature monitoring, which can overcome or at least alleviate the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a characteristic curve of a thermal diode used in a temperature sensitive alarm circuit, according to an exemplary embodiment.

FIG. 2 is a circuit diagram of the temperature sensitive alarm circuit of FIG. 1.

### DETAILED DESCRIPTION

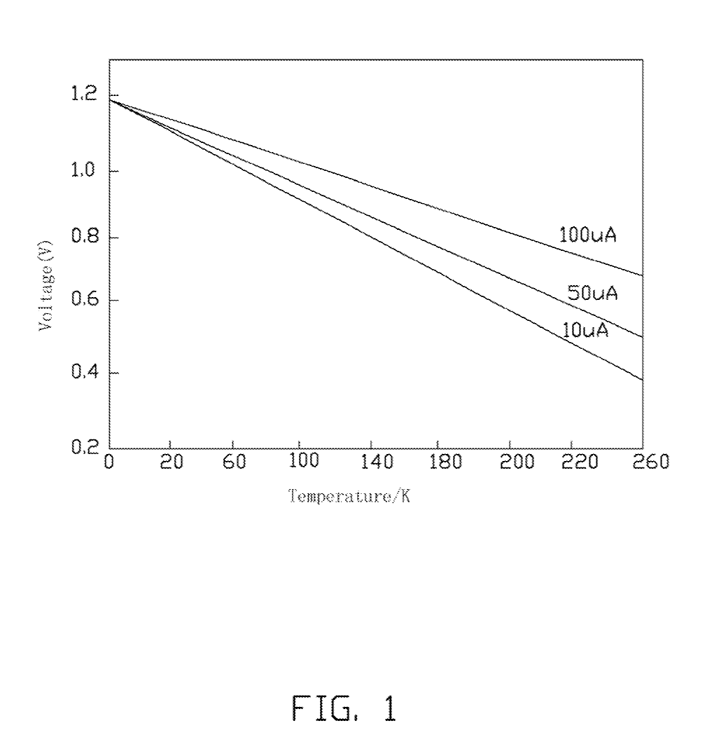

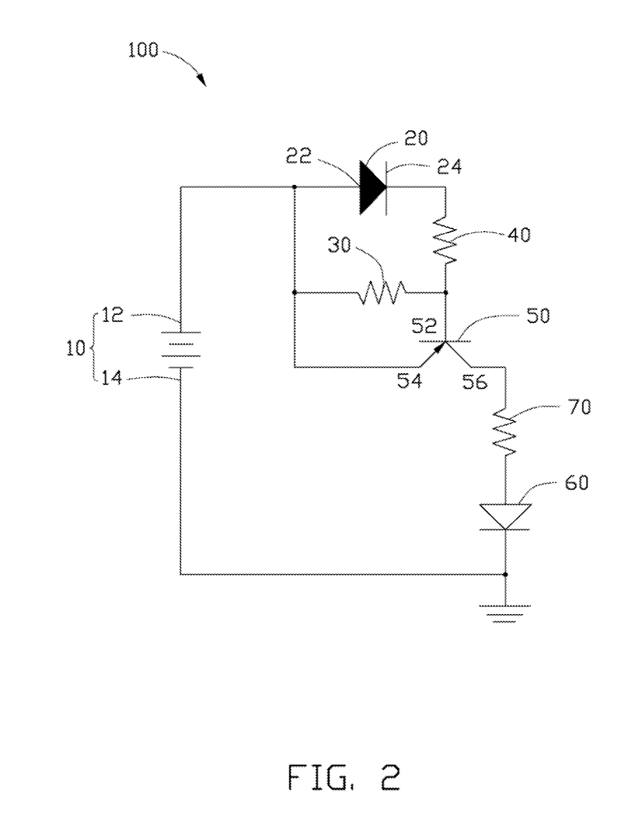

Referring to FIGS. 1 and 2, a temperature sensitive alarm circuit 100 according to an exemplary disclosure, includes a power source 10, a thermal diode 20, a first resistor 30, a second resistor 40, a pnp-type transistor 50, and an alarm 60.

The power source 10 includes a high level terminal 12 and a low level terminal 14. The high level terminal 12 is connected to the thermal diode 20, while the low level terminal 14 is grounded. In the present disclosure, the power source 10 is a DC power source.

The thermal diode 20 includes an anode 22 and a cathode 24. The anode 22 is connected to the high level terminal 12 of the power source 10 while the cathode 24 is connected to the second resistor 40. The thermal diode 20 is characterized by a higher forward voltage drop as temperature decreases. In the present disclosure, the forward voltage drop of the thermal diode 20 increases 2 millivolts (mV) when the temperature decreases 1 degree. In the present disclosure, the thermal diode 20 is made of silicon semiconductor material. In other embodiments, the thermal diode 20 may be made of other materials with an expected characteristic.

The first resistor 30 is connected in parallel to the thermal diode 20 and the second resistor 40 which are connected in series.

The transistor 50 includes a base 52, an emitter 54, and a collector 56. The base 52 and the emitter 54 are respectively connected to two terminals of the first resistor 30. In the present disclosure, the base 52 is connected between the first resistor 30 and the second resistor 40, while the emitter 54 is connected between the anode 22 of the thermal diode 20 and the first resistor 30. The collector 56 is connected to the low level terminal 14 of the power source 10 via a third resistor 70 and the alarm 60.

The alarm 60 is connected between the collector 56 and the low level terminal 14 of the power source 10. In the present disclosure, the alarm 60 is an LED. In other embodiments, the alarm 60 may be some other alarm device, such as a buzzer. The third resistor 70 is connected to the alarm 60 in series.

When the temperature decreases, the forward voltage drop of the thermal diode 20 is increased, thus a voltage drop across the first resistor 30 is also increased. When the voltage drop across the first resistor 30 reaches a turn-on voltage of the transistor 50, the transistor 50 turns on and activates the alarm 60. Thus, when ambient temperature drops below a predetermined value, an operator can be alerted by the alarm 60.

While various exemplary and preferred embodiments have been described, it is to be understood that the disclosure is not limited thereto. Various modifications and similar arrangements can also be covered as would be apparent to those skilled in the art.

Therefore, the scope of the appended claims should be accorded the broadest interpretation so as to encompass all such modifications and similar arrangements.

What is claimed is:

1. A temperature controlling alarm circuit comprising:
a power source comprising a high level terminal and a low level terminal, the low level terminal being grounded;
a thermal diode comprising an anode and a cathode, the anode connected to the high level terminal of the power source;
a resistor connected to the thermal diode in series;
another resistor connected in parallel to the thermal diode and the said resistor which connected in series;
a pnp-type transistor comprising a base, an emitter and a collector, the base and the emitter respectively connected to two terminals of said another resistor;
an alarm connected between the collector of the transistor and the low level terminal of the power source.

2. The temperature controlling alarm circuit of claim 1, wherein the power source is a DC power source.

3. The temperature controlling alarm circuit of claim 1, wherein the thermal diode is made of silicon semiconductor material, the thermal diode is characterized by a higher forward voltage drop as the temperature decreases.

4. The temperature controlling alarm circuit of claim 1, further comprising a third resistor connected to the alarm in series.

5. The temperature controlling alarm circuit of claim 1, wherein the alarm is an LED.
